(19) United States
(12) Patent Application Publication
(10) Pub. No.: US 2010/0238658 A1
(43) Pub. Date: Sep. 23, 2010

(54) LED LAMP

(75) Inventors: QIAN XIANG, Shenzhen City (CN); GUANG YU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/508,586

(22) Filed: Jul. 24, 2009

(30) Foreign Application Priority Data
Mar. 21, 2009 (CN) 200910301023.5

(51) Int. Cl. F21V 1/00

(52) U.S. Cl. 362/235; 362/373

(57) ABSTRACT

An LED lamp includes a housing, a pair of heat sinks mounted at two opposite sides of the housing, a plurality of LEDs mounted on the two heat sinks, respectively, a reflector received in the housing, and a cover fixed on the housing. The reflector is wave-shaped and includes multiple facets located at different levels and oriented towards different directions. Each heat sink includes a substrate sandwiched between a base and a frame fixed on the base of the housing, and a plurality of fins extending outwardly from the substrate. The LEDs are mounted on the substrates and face the reflector. The cover is received in a window opened in the frame of the housing to face the reflector.

### BACKGROUND

1. Technical Field

The present disclosure relates to a light emitting diode (LED) lamp, and more particularly, to an LED lamp having a low cost.

2. Description of Related Art

LEDs have been available since the early 1960's. LED use has increased in a variety of applications, such as in residential, traffic, commercial, and industrial settings, because of the high light-emitting efficiency of LEDs. The applications each have its special light pattern depending on the occasion where the application is applied. For some of these applications, solid light output is often desired in order to illumination of a large area. This is generally achieved by placing a large amount of LEDs within the lamp in different levels and orientations. The light beams generated from the LEDs could be radiated towards respective orientations from respective levels, thereby providing a wide illumination to the object to be illuminated.

Compared with other elements of the lamp, the LEDs are relatively expensive for their high manufacturing cost. That is to say, the more LEDs are used, the more cost of the lamp is required. Particularly, for some kinds of lamps used in outdoors, the cost ratio of the LEDs to the whole lamp could reach nearly 50%. Thus, it is costly to apply so many LEDs in the lamp in order to provide the wide illumination.

What is needed, therefore, is an LED lamp which can overcome the above-mentioned disadvantages.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled view of an LED lamp of this disclosure.

FIG. 2 is an exploded view of the LED lamp of FIG. 1.

FIG. 3 shows a part of the LED lamp of FIG. 2.

FIG. 4 shows a cross-section of the LED lamp of FIG. 1.

### DETAILED DESCRIPTION

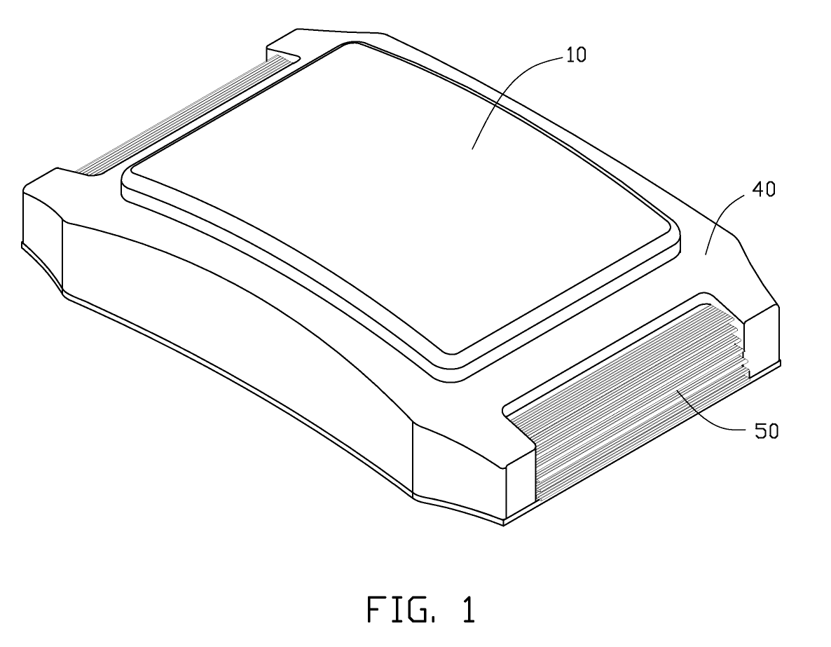

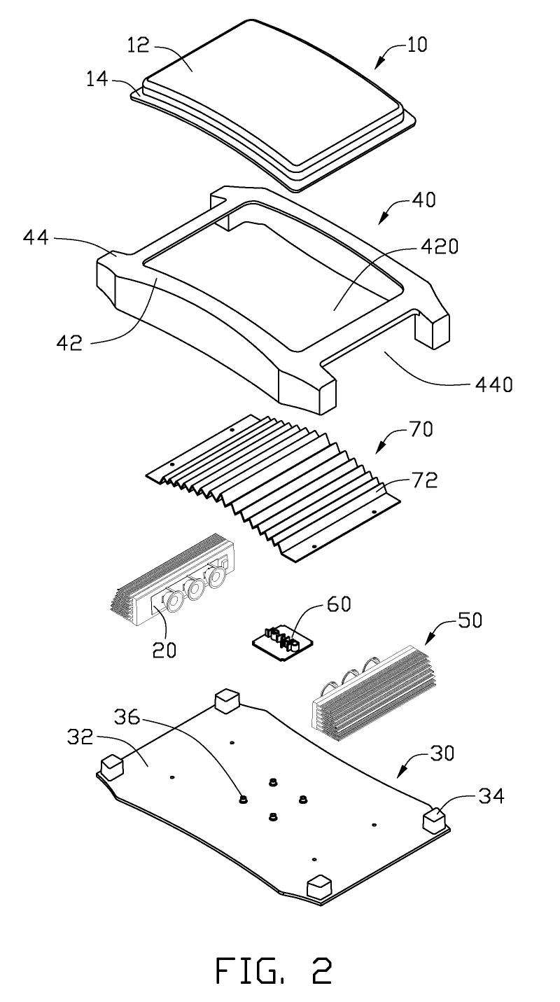

Referring to FIGS. 1-2, an LED lamp of this disclosure is presented. The LED lamp includes a housing, a pair of heat sinks 50 received in the housing, two LED units 20 mounted on the two heat sinks 50, a reflector 70 mounted in the housing, and a cover 10 fixed to the housing and covering the reflector 70. The housing includes a base 30 and a frame 40 secured on the base 30. The base 30 includes a plate 32 having a rectangular configuration with four corners thereof truncated. Four blocks 34 are protruded upwardly from the plate 32 adjacent to the four corners thereof, respectively, for insertion to the frame 40 to thereby position the frame 40 to the base 30. Each block 34 has a trapezoid cross-section with a tapered end thereof facing upwardly. Four posts 36 are protruded upwardly from the plate 32 at a central area thereof, for positioning a driving module 60 on the base 30. The frame 40 has a profile in consistent with that of the base 30. The frame 40 includes an upwardly curved panel 42 and a pair of arms 44 formed at two opposite sides of the panel 42, respectively. The panel 42 defines a rectangular window 420 at a central area thereof for receiving the cover 10 therein. Two opposite distal ends of each arm 44 horizontally protrudes out of the panel 42, wherein each end of the arm 44 is hollow to fittingly receive a corresponding block 34 of the base 30 therein. Every two confronting ends of the two arms 44 define a gap 440 therebetween, to accommodate a corresponding heat sink 50 in the frame 40.

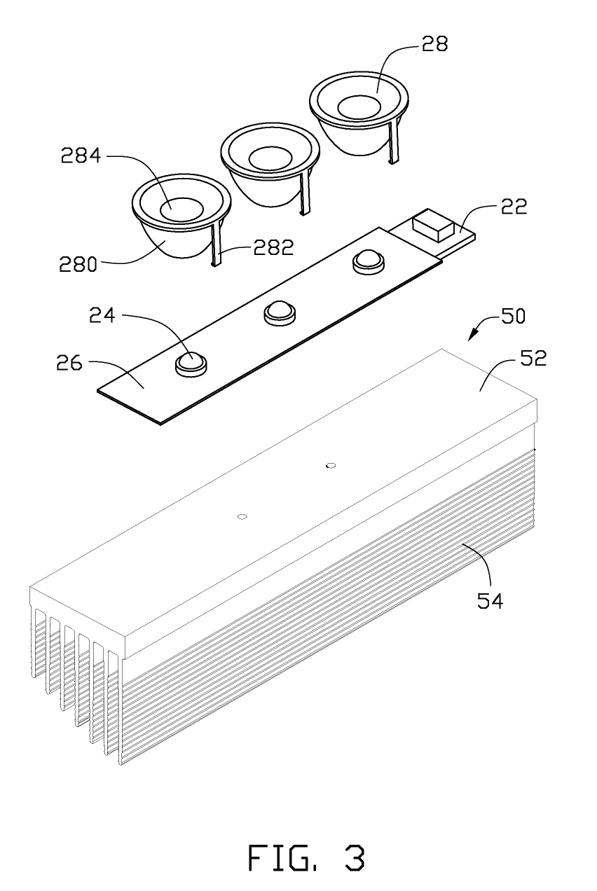

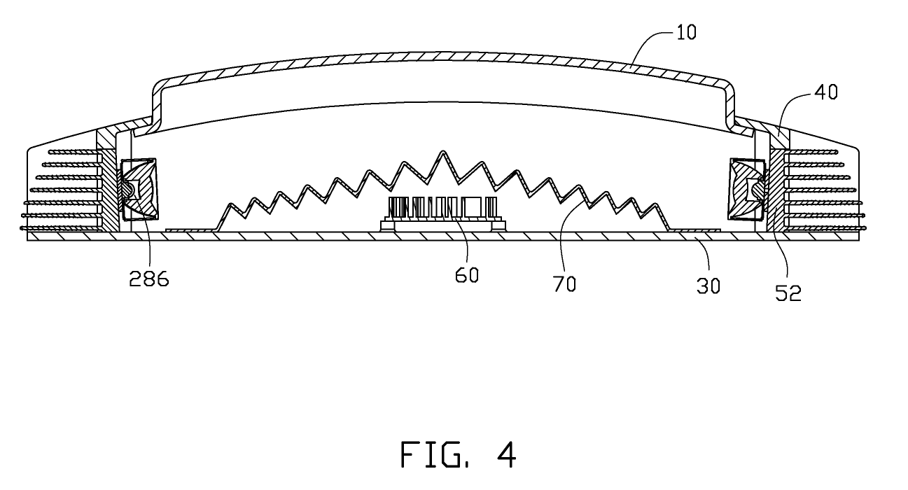

Also referring to FIGS. 3-4, the two heat sinks 50 are located on the base 30 and in the two gaps 440 in the frame 40, respectively. Each heat sink 50 includes a substrate 52 and a plurality of fins 54 extending outwardly from an outer face of the substrate 52. The substrate 52 is sandwiched between the frame 40 and the base 30, and the fins 54 are exposed within a corresponding gap 440 in the frame 40 (see FIG. 4). The substrate 52 has a thickness decreasing upwardly; thus, when the heat sink 50 is disposed on the base 30 with a bottom face of the substrate 52 abutting against a top face the base 30, the outer face of the substrate 52 would be oriented perpendicular to the top face of the base 30, and an inner face of the substrate 52 would be slightly inclined upwardly towards an exterior of the housing. The fins 54 have lengths increasing downwardly to increase heat dissipation areas of the heat sink 50.

Each LED unit 20 includes an elongated printed circuit board 22, a plurality of LEDs 24 mounted atop the printed circuit board 22, a strip 26 covering the printed circuit board 22 in which the LEDs 24 protrude through the strip 26, and a plurality of lens 28 secured to the strip 26 and receiving the LEDs 24 therein, respectively. The strip 26 has a width larger than that of the printed circuit board 22, whereby two opposite longer sides of the strip 26 extend beyond the printed circuit board 22. Each lens 28 includes a conical outer surface 280 and a flared top surface 284, for concentrating light emitted from the LED 24 into a beam. Each lens 28 has a leg 282 extending towards the printed circuit board 22. The leg 282 is for locking with a corresponding longer side of the strip 26 extending beyond the printed circuit board 22, thus securing the lens 28 on the strip 26. When the printed circuit board 22 is fixed on the inner face of the substrate 52 of the heat sink 50, the LEDs 24 would be horizontally positioned towards a slightly upward direction, and the light beams output from the LEDs 24 via the lens 28 would be directed towards the reflector 70 in a slightly upward manner.

The reflector 70 is substantially received in the housing and faces the window 420 in the frame 40. The reflector 70 is formed by folding a reflective rectangular sheet into a wave-like configuration. The reflector 70 consists of multiple continuous facets 72 which are arranged at different levels and oriented towards different directions. In detailed, the facets 72 are gradually raised from two opposite ends towards a center of the reflector 70, and every two adjacent facets 72 cooperatively define an acute angle therebetween. The two opposite ends of the reflector 70 are fixed on the top face of the base 30 to cover the driving module 60. The facets 72 of the reflector 70 could reflect the light beams from the lens 28 towards different orientations from different levels, thus achieving an effect of a homogenous light, which can be obtained only when the lamp is equipped with a large number of LEDs. Since the cost of the reflector 70 is relatively low compared with the LEDs 24, the total cost of the LED lamp is reduced.

The cover 10 is also curved upwardly like the panel 42 of the frame 40. The cover 10 includes an envelope 12 and a flange 14 extending outwardly and horizontally from a circumference of a bottom of the envelope 12. The flange 14 abuts against a bottom of the panel 42 of the frame 40, to thereby secure the cover 10 to the frame 40. The envelope 12 is made of frosted glass or plastic so that the light diffusely reflected by the reflector 70 would be further diffused after passing the cover 10.

Using the two diffusion structures, the light output from the LED lamp could be distributed relatively uniformly, thereby improving illumination effect on the object to be illuminated.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

1. An LED (light emitting diode) lamp comprising:
a housing having a light-transmitting window;
a plurality of LEDs received in the housing; and
a reflector mounted to the housing and facing the window;
wherein light emitted by the LEDs is reflected by the reflector towards different orientations.

2. The LED lamp as claimed in claim 1, wherein the reflector comprises multiple facets oriented towards different directions.

3. The LED lamp as claimed in claim 2, wherein every two adjacent facets defines an acute angle therebetween.

4. The LED lamp as claimed in claim 2, wherein the multiple facets are located at different levels.

5. The LED lamp as claimed in claim 4, wherein the facets are raised towards the window from two opposite ends towards a center of the reflector.

6. The LED lamp as claimed in claim 1, wherein the plurality of LEDs are oriented towards an interior and the window of the housing.

7. The LED lamp as claimed in claim 1, wherein a pair of heat sinks are mounted at two opposite sides of the housing, and the plurality of LEDs are mounted on the pair of heat sinks, respectively.

8. The LED lamp as claimed in claim 7, wherein the housing comprises a base and a frame fixed on the base, and each heat sink includes a substrate standing on the base and a plurality of fins extending outwardly from the substrate.

9. The LED lamp as claimed in claim 8, wherein the substrate of each heat sink is sandwiched between the frame and the base of the housing.

10. The LED lamp as claimed in claim 8, wherein the substrate of each heat sink has an outer face perpendicular to the base, and an inner face inclined relative to the base, the plurality of LEDs being mounted on the inner face of the substrate of each heat sink.

11. The LED lamp as claimed in claim 8, wherein the frame defines two gaps at the two opposite sides of the housing, and the fins of the heat sinks are received in the two gaps, respectively.

12. The LED lamp as claimed in claim 8, wherein a driving module for driving the LEDs to lighten is located between the reflector and the base of the housing.

13. The LED lamp as claimed in claim 1, wherein the plurality of LEDs are mounted on two printed circuit boards, and a plurality of lens are fixed to the printed circuit boards corresponding to the LEDs, respectively.

14. The LED lamp as claimed in claim 13, wherein each printed circuit board has a strip mounted thereon, the strip covering the printed circuit board wherein corresponding LEDs mounted on the each printed circuit board protrude through the strip.

15. The LED lamp as claimed in claim 14, wherein the strip has two opposite sides extending beyond the each printed circuit board, and each lens has a leg hooked with the strip.

16. The LED lamp as claimed in claim 1 further comprising a cover fixed at the window in the housing, and the light is diffusible by the cover when the light passes through the cover.

17. The LED lamp as claimed in claim 16, wherein the cover is made one of frosted glass and plastic.
